(19) United States
(12) Patent Application Publication
(10) Pub. No.: US 2004/0210518 A1
(43) Pub. Date: Oct. 21, 2004

(54) Wire transfer system and method

(76) Inventor: Marvin Van Tiem, Zionsville, IN (US)

Correspondence Address: Noreen O'Hara Welch, STEVENS, DAVIS, MILLER & MOSHER, LLP, Suite 850, 1615 L Street, N.W., Washington, DC, 20036, US

(21) Appl. No.: 10/626,546

(22) Filed: Jul. 25, 2003

Related U.S. Application Data
(60) Provisional application No. 60/399,693, filed on Aug. 1, 2002.

(51) Int. Cl. G06F 17/60

(52) U.S. Cl. 705/39

(57) ABSTRACT

A system and method for automating the request and approval of wire transfer is provided. A web-enable system and method allows the treasury department of a financial services organization to collect all wire transfer information directly from a submitter. Approval for the wire transfer is granted by a specific set of user within a receiving organization. Reporting and archiving provide documentation of transactions that have occurred and resubmission of wires. Accuracy and efficiency of wire request processing results from elimination of re-keying of wire request information.

### CROSS REFERENCE TO RELATED APPLICATION

This application is a non-provisional claiming benefit of U.S. Provisional Application No. 60/399,693 filed Aug. 1, 2002 which is hereby incorporated by reference in its entirety.

### BACKGROUND OF THE INVENTION

1. Field of the Invention

The present invention relates to the processing of wire transfers and more particularly to the automated the processing wire transfers in the financial services industries, and most particularly to Web-enabled automated processing of wire transfers by a financial services institution.

2. Discussion of the Related Art

The current process for collecting, entering, and executing wire transfers is a very cumbersome manual process. The wire requests are handwritten and faxed to the responsible organization within a financial institution. Then the responsible organization is burdened with reviewing and approving each wire. Finally, the responsible organization must re-key all of the information for execution by a bank.

### SUMMARY OF THE INVENTION

Thus, there is a need for an efficient system and method for capturing wire information at its source such that it can be maintained, accessed and transferred among the parties that process this information.

Objectives of the present invention comprise making the capturing of wire information and processing of wire transfers less error-prone and much more automated, standardized, user-friendly, available, and less demanding on the organization responsible for processing wire transfers, e.g., a Treasury Department of a financial services organization. The present invention is a web-enabled system and method that allows the Treasury Department of a financial services organization to collect all of the wire transfer information directly from a submitter. Then the approval for the wire can be granted by a specific set of users within the receiving organization, thereby relieving the processing organization of this duty. Finally, the processing organization is relieved of the re-keying of all wires received.

In addition to streamlining the wire transfer process, other advantages of the system and method of the present invention are its reporting and archiving functionalities. The reporting and archiving functionalities allow users to produce detailed reports about recent and past wires. The reports are intended for use in the analysis of wire information to produce information such as trends in wire submitters, account numbers, and dates. These reports also provide accurate evidence of transactions that have occurred in the event of a dispute concerning payment. Archived information can be reproduced to re-submit wires or to check specifics of the wires that have been submitted to a bank.

FIGS. 1A and 1B illustrate a work flow of the system and method of the present invention. FIGS. 2-7 provide a subset of screen images of a preferred embodiment of this workflow as a Web-enabled business method, such as eWire. The following sections provide an overview the functions accomplished by this workflow.

1. Login 100

Users will enter the application through the Login Page (FIG. 2). The following are the links provided in this page:

1.1 New User Registration 200

New users (only submitters) can register themselves by clicking on the New User Registration link 200 to obtain a registration form. Users need to provide the basic information requested by this form, select an Approver Group from a List box and submit the form. If the information entered is correct, a confirmation page will appear stating that their registration has been submitted successfully. All Approvers belonging to the user selected Approver Group can see the submitted registration forms. They can Approve or Reject the User registration forms. In either case, an e-mail will be sent to the User which confirms whether user registration has been approved or rejected.

1.2 Forgot Password 201

Any User of the application who forgot their password can get to know their password provided they enter their user id and answer to a Hint Question correctly. Upon clicking link ‘Forgot Password’ 201 the user will be taken to a page where he needs to enter his User Id. If the User Id is valid a Hint Question from a User Profile of the User will be displayed. Here, User has to enter the Hint Answer to the question. If the Hint Answer is correct an e-mail with the Password will be sent to the e-mail address that is stored with the User Profile.

2. Wire Submission 108

FIG. 3 illustrates a preferred embodiment of a Submitter's Home Page showing the number of wires that the submitter has submitted and the status of the wires. The other links contained in a preferred embodiment of the page are briefly described below.

2.1 View Template 302

In this page the list of templates created by a Submitter is shown. A Submitter can submit a wire through a Template also. A Submitter can view a Template by clicking on Template ID or can delete the Template by clicking on the Delete button. A Submitter has to confirm when deleting a Template.

2.2 Enter New Wire 300

A Submitter can choose this link to raise a new Wire. This consists of a process which consists of steps in which the User needs to answer specific questions and a Wire wizard is generated accordingly. FIG. 3A shows a display in which the Submitter is asked 310 whether the Submitter wants to enter information for a new wire transfer 311 or wants to use an existing Template 312. When the Submitter clicks New Wire 311, the Submitter must indicate whether the transfer requires an intermediary bank, as illustrated in FIG. 3B. If the Submitter clicks Yes, the Submitter must enter the ABA number or the Intermediary Bank Account number 330, as illustrated in FIG. 3C. If the Submitter clicks No, a corresponding Wire Submission Form is directly opened.

FIG. 3C illustrates where the user submits the ABA number. On submit the number is validated against a list of valid ABA numbers to make sure the number supplied is valid. If the ABA number is not valid the application does not leave that page (FIG. 3C) and the user is asked to enter a new ABA number. If the number entered by the Submitter is valid, the Submitter has to select ABA Routing number 340 or Account number 341 for the submission of Wire Information, as illustrated in FIG. 3D. If the Submitter selects ABA Routing number/Account Number, corresponding Wire Submission forms are opened as illustrated in FIGS. 3E.1-2 and FIGS. 3F.1-3

A Submitter can save the new wire information as a Template. A popup screen solicits the name of the Template. This Template can be used for wire submission if the user selects “View Template” 302 in FIG. 3.

A Submitter can post a wire and the wire details are submitted and forwarded to an Approver. The Submitter can also Post a wire after saving it as Template.

2.3 Research 303

A typical research input screen comprises various search criteria to be used to retrieve the Wires submitted by the logged-in Submitter. The user can enter or select at least one search field or can fill a maximum of all fields and click on the submit button. The user can click on a Create Spreadsheet Extract button to create a spreadsheet and he has to enter the local folder path in the pop up box. The flat file will be stored in the entered address.

2.4 Change Personal Information 301

This page is used to modify the Personal Information of a Submitter.

3. Wire Approval 109, 135

FIG. 4 illustrates a preferred embodiment of an Approver's Home Page that displays all the wires submitted for approval by the Approver. The Approver clicks on a Wire ID Link 400 to check the details of the wire. In the resulting display, the wire information can be either Approved or Rejected or set to an Alert status. Wires submitted after CutOff time are marked with a clock icon 401.

In a preferred embodiment, the following are the Hyperlinks provided in the Approver's home page as shown in FIG. 4.

3.1 Session Summary 402

Selecting this link takes the Approver to a display of a list of all wires in that particular session with Date/Stamp details.

3.2 Registration Approval 403

Selecting this link takes the Approver to a display of the list of users waiting for Registration. In a preferred embodiment, two Approvers are required to approve a registration in order to create a user account.

3.3 Administer Submitter Status 404

Selecting this link takes the Approver to a display of a list of users. Each user can be made Active or Inactive, in a preferred embodiment.

3.4 Research

This screen consists of various search criteria to retrieve Wires by the logged in user. The user can at least enter or select one field or can fill a maximum of all fields and submit for the results. The user can click on Create Spreadsheet Extract button to create a spreadsheet and he has to enter the local folder path in the pop up box. The flat file will be stored in the entered address.

4. Wire Confirmation 111, 146

The Home Page for the Final Admin user is illustrated in FIG. 5. Final Admin is a user who finally confirms all the wires, after which the wire information is ready for the extract. In a preferred embodiment, Final Admin confirms each wire by clicking the “Check All” button 503 and then clicking the “Final Confirm” Button 504. The wires whose status is Alert need to be confirmed by Two Super Admins. The wire information can be viewed by clicking the Wire Id Hyperlink 505. Alerted wires will be marked with exclamation symbol (!) 506.

The functions available in a preferred embodiment are shown as hyperlinks in FIG. 5 and are described as follows.

4.1 Create Extract 500

When this option is selected, two files are created, listing wire that have been created since the last extract. The first file will be saved using a predetermined path and will have the same name every time, overwriting the currently existing file. This file is to be downloaded to the user's system. This is the file that will be imported by the target system. At the same time, an exact duplicate of this file will be created in another directory as a second extract and will be named using a convention that includes the date and time of the creation, such as “MMDDYYHHMM” (for example: “120300-1625” would be a file created on Monday, Dec. 3, 2000 at 4:25 PM). The second extract is strictly for archival purposes.

4.2 Re-create Extract 501

If the user wants to recreate an extract for already extracted wires, the user specifies the range of dates and a list of Extracts will be displayed with an option button for selection of each extract in order to view the wires included in a particular extract. In a preferred embodiment, a page is displayed with all wires included in that particular Extract formatted in a table. Details of any wire can be obtained by clicking on the Wire ID of the desired wire.

4.3 Research 502

In a preferred embodiment, a display is presented comprising various search criteria to be used to retrieve wires submitted by the logged-in use, wherein the user can at least enter or select one field or can fill a maximum of all fields and submit for the results. Further, the user can click on a “Create Spreadsheet Extract” button to create a spreadsheet and then the user has to enter the local folder path (address) in a pop up box. The flat file containing the spreadsheet extract will be stored in the entered address.

5. System Administration 112, 153

FIGS. 6A-B illustrate a home page screen for a Super Admin or system administrator, comprising several tables:

a. 600—users created by another Super admin and which needs the approval of the current Super Admin.

b. 601—users whose password has been changed by another Super Admin and needs the approval of the current Super Admin

c. 602—users who have been suspended by having failed to log-on into the application within three attempts.

d. 603—: wires that have been made Alerted by an Approver which need the approval of the current Super Admin.

e. 604—wires that are waiting for Final Confirmation.

The following is the description of the functions available in a preferred embodiment and shown as Hyperlinks in FIG. 6A.

5.1 User Maintenance 605

5.1.1 Edit User—The Super Admin has to search for the user in order to edit his personal information. The Super Admin can view the details of the user.

5.1.2 Add User—The Super Admin can add any type of user and, in a preferred embodiment, another Super Admin must approve this added user.

5.2 Post Message 608

A Super Admin enters a message and submits it to the DB. This message is now displayed on the Home page of the Application.

5.3 Auto E-mail Administration 607

The content of the e-mails for the contexts such as Submitter approval, Rejection and Wire approval, rejection, and duplicate wire message can be edited.

5.4 Cut Off Time Administration 606

A Super Admin can set the cut off time for wire submission.

5.5 Approver Maintenance 609

Approvers can be associated to any Approver group. One list box (Approver Pool) to display all the existing Approvers is provided and one combo box for the selection of “To Approver Group” and the another list box which consists of Approvers of the selected Approver group. Approvers can be moved from Approver Pool to the selected “To Approver Group” List Box.

5.5.1 Create Group—In a preferred embodiment, two list boxes are provided one of which displays the Approvers of the selected Approver. The Approvers are moved to a right list box (empty initially). A name is given to the new Approver Group and the information is submitted. The Approver Groups can be edited or deleted.

5.5.2 Delete Group—A required Approver Group is selected for deletion.

5.6 Submitter Maintenance

Submitters from the Submitter Pool will be associated with a selected Approver Group. At any time a Submitter is associated with only one Approver Group.

5.7 A/c Number Maintenance 611

The Super Admin can add Account numbers and their descriptions. In a preferred embodiment, these numbers appear in a drop-down box, e.g., for selection by a Submitter.

5.8 Create Extract

Information concerning wires that have been approved will be extracted to a first file and saved in a specific directory. The same file is stored with the name in a predetermined format, i.e., in a preferred embodiment with the Date of creation in a different path for the archival purpose. The first file is always replaced with fresh wires.

5.9 Recreate Extract 614

If the user wants to recreate an extract for already extracted wires, the user specifies the range of dates and a list of Extracts created within that date range will be displayed with an option button for each extract.

5.10 Research 615

The user may specify various search criteria to retrieve wires submitted by all the users. This list can be formatted as a Spread Sheet extract and saved for future reference and transfer.

6. Research 110

FIG. 7 illustrates a home page for a Researcher, according to a preferred embodiment. A Researcher is a user who provides the various search criteria for wires. RunQuery button 700 is used to retrieve the wires according to the entered criteria. The retrieved wires list can be formatted as a Spread Sheet extract and is saved on the client side by clicking the button Create SpreadSheetExtract 701. A Researcher can search the wires of all users.

Because of its sensitive nature, the system and method of the present invention employs encryption, such as SSL (Secure Socket Layer), throughout to reduce the likelihood that user or wire information is compromised.

In a preferred embodiment, the system and method of the present invention is a SSL encrypted web-enabled application that automates and standardizes the process of wire transfer for the organization responsible for processing wire transfers. The present invention spans an intake function that takes in the wire information submitted by submitters up to the creation of an extract of the wire information by an authorized function, e.g., Super admin function, for approved wires.

### BRIEF DESCRIPTION OF THE DRAWINGS

FIGS. 1A-1B are an overview of wire transfer functional flow according to the system and method of the present invention.

FIG. 2 is an example of new user registration page or login page, according to an embodiment of the present invention.

FIG. 3 is an example of a Submitter's home page, according to an embodiment of the present invention.

FIG. 3A illustrates a page soliciting user selection of New Wire of Existing Template.

FIG. 3B illustrates a page requesting information concerning intermediary banks for a New Wire.

FIG. 3C illustrates a page requesting the ABA or routing number for an intermediary bank.

FIG. 3D illustrates a page requesting further information for a correctly entered ABA or routing number in FIG. 3C.

FIGS. 3E.1-2 illustrate pages requesting detailed information describing the wire submission when an ABA number is supplied in FIG. 3D.

FIGS. 3F.1-3 illustrate pages requesting detailed information describing the wire submission when an account number is specified in FIG. 3D.

FIG. 4 illustrates and Approver's home page.

FIG. 5 illustrates a Final Admin's home page.

FIG. 6A-B illustrate a Super Admin's home page.

FIG. 7 illustrates a Researcher's home page.

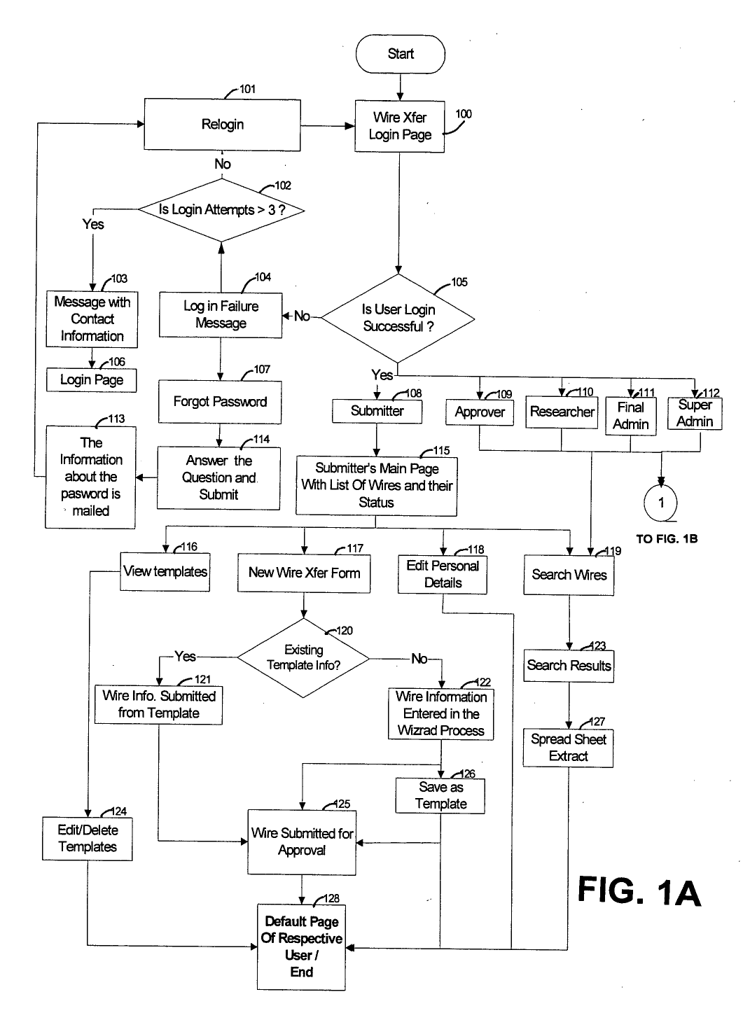

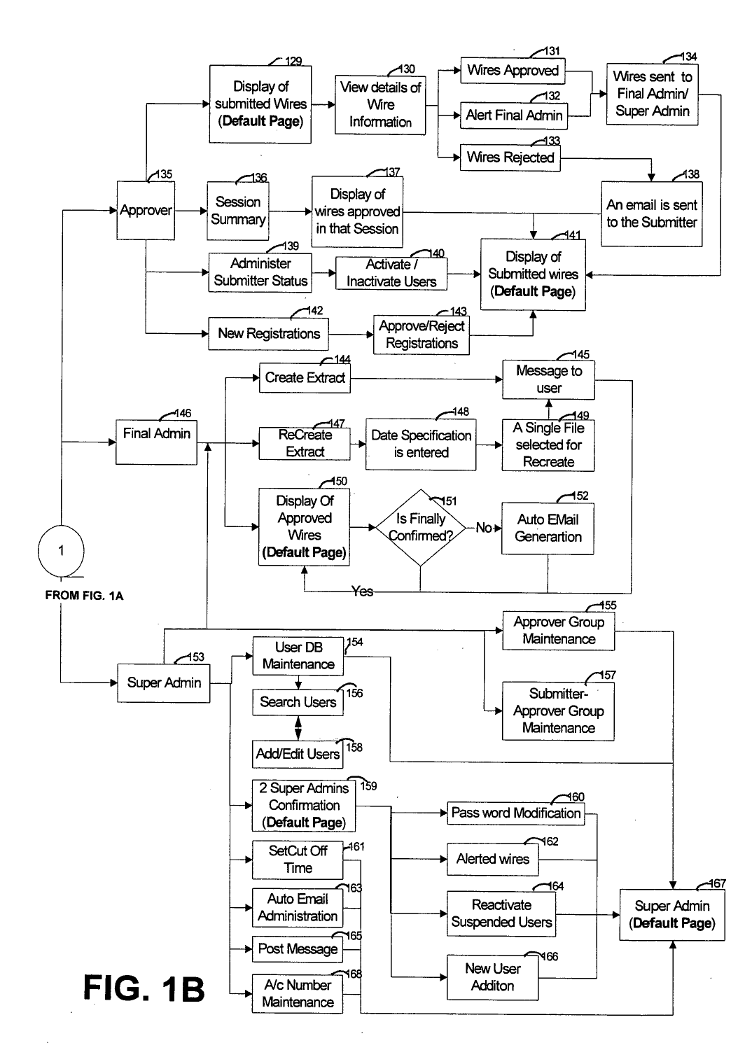

### DETAILED DESCRIPTION

The system and method of the present invention comprises a set of functions selectively available to a set of users.

1. User Roles

In a preferred embodiment, there are at least four types of user roles: Submitter, Approver, Researcher, and Admin.

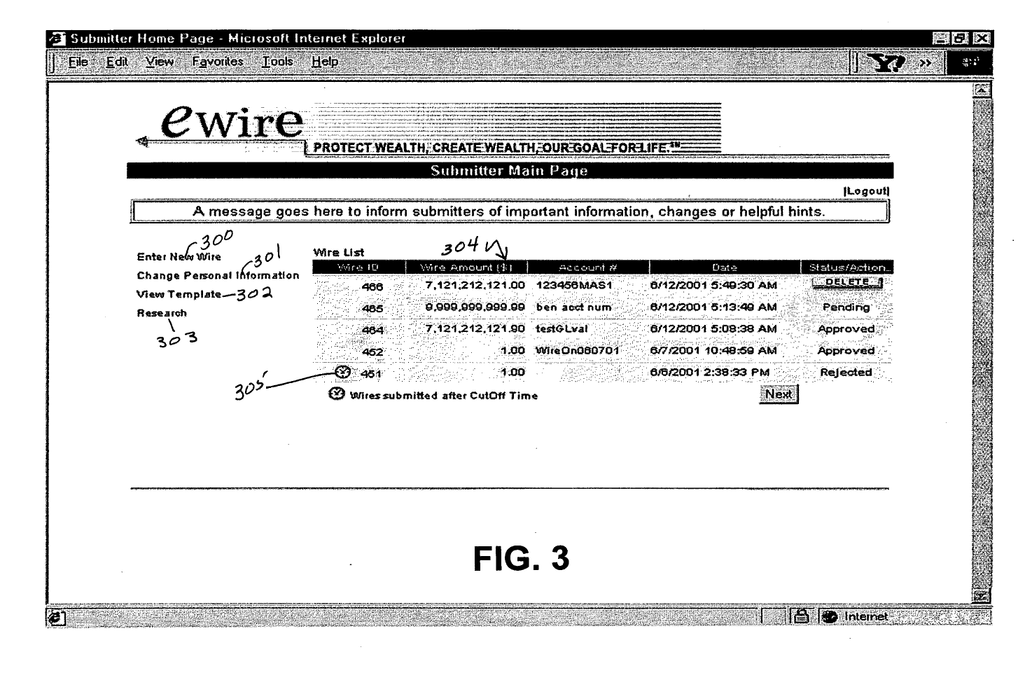

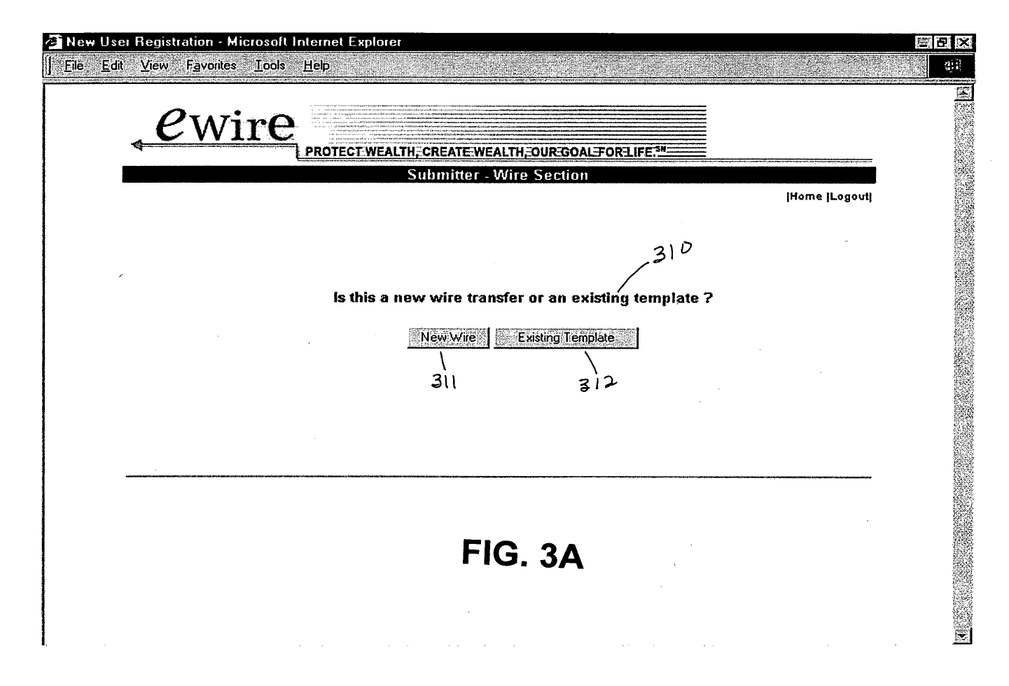

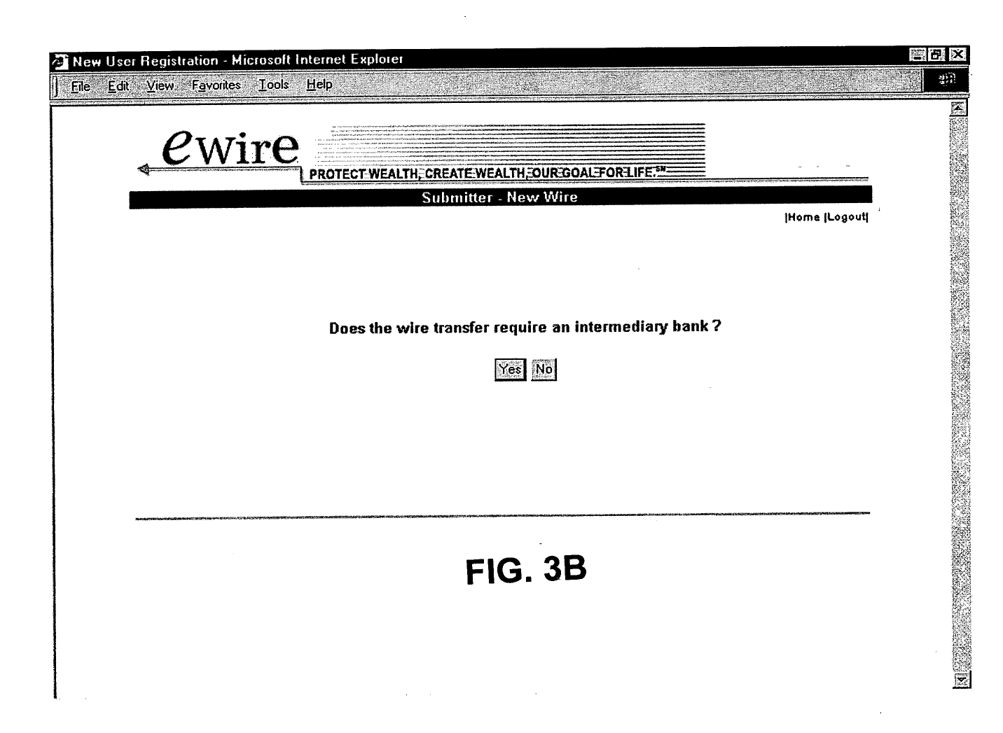

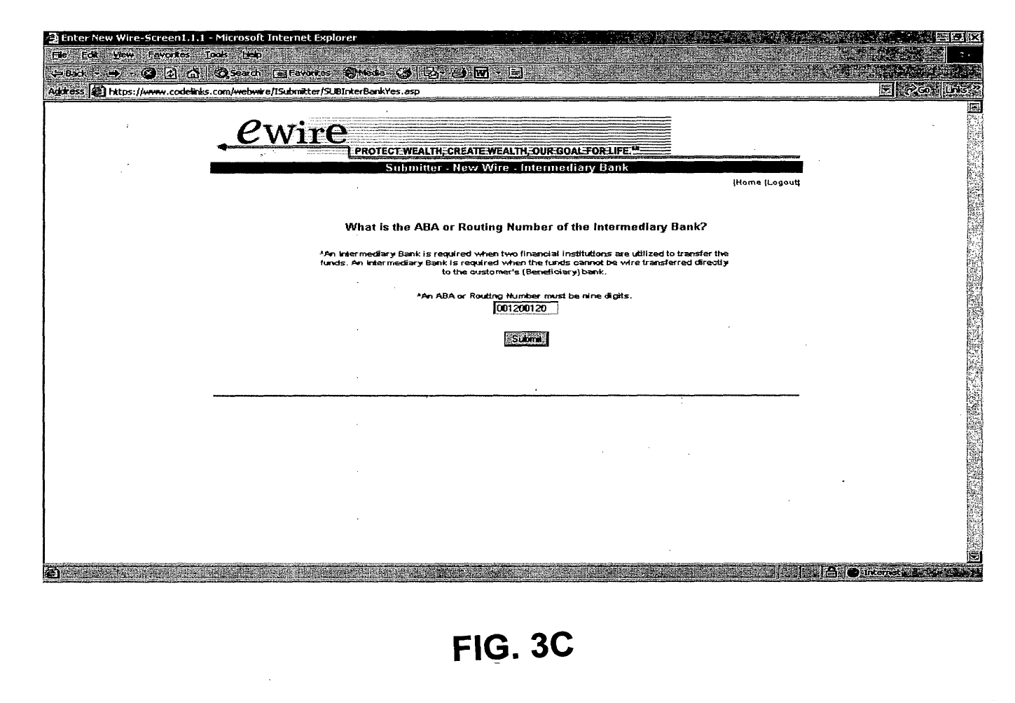

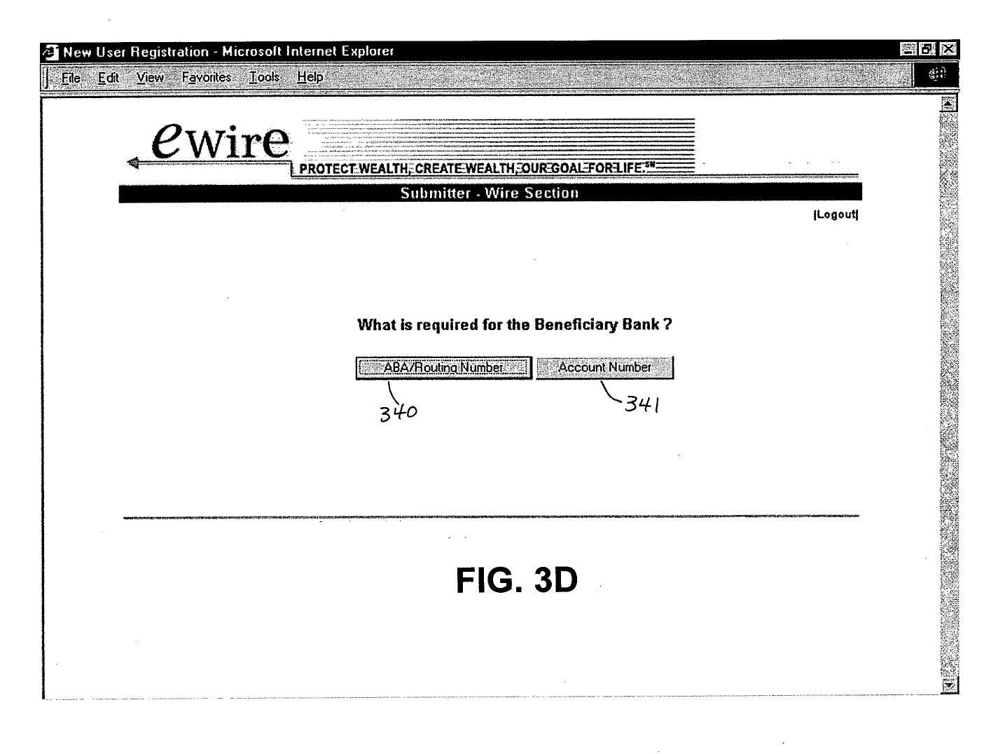

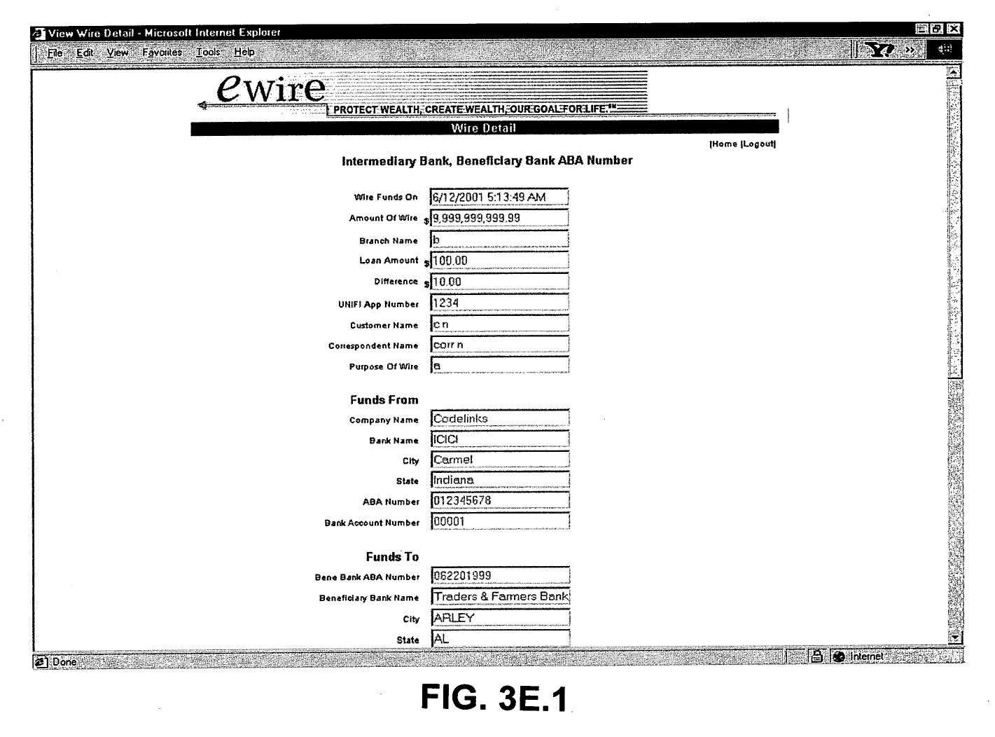

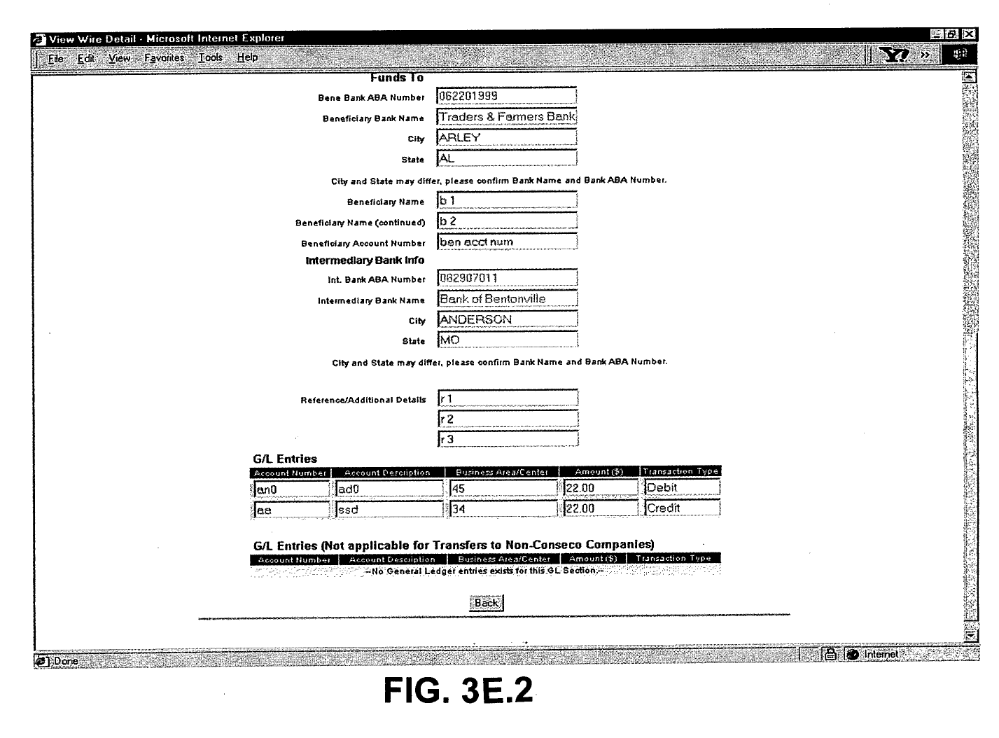

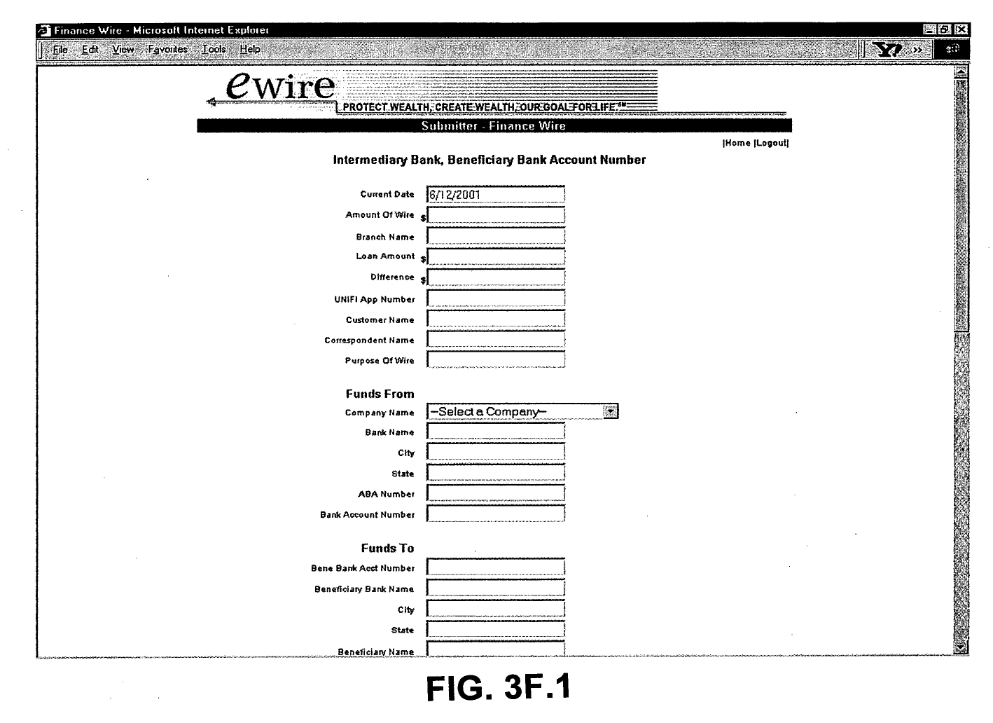

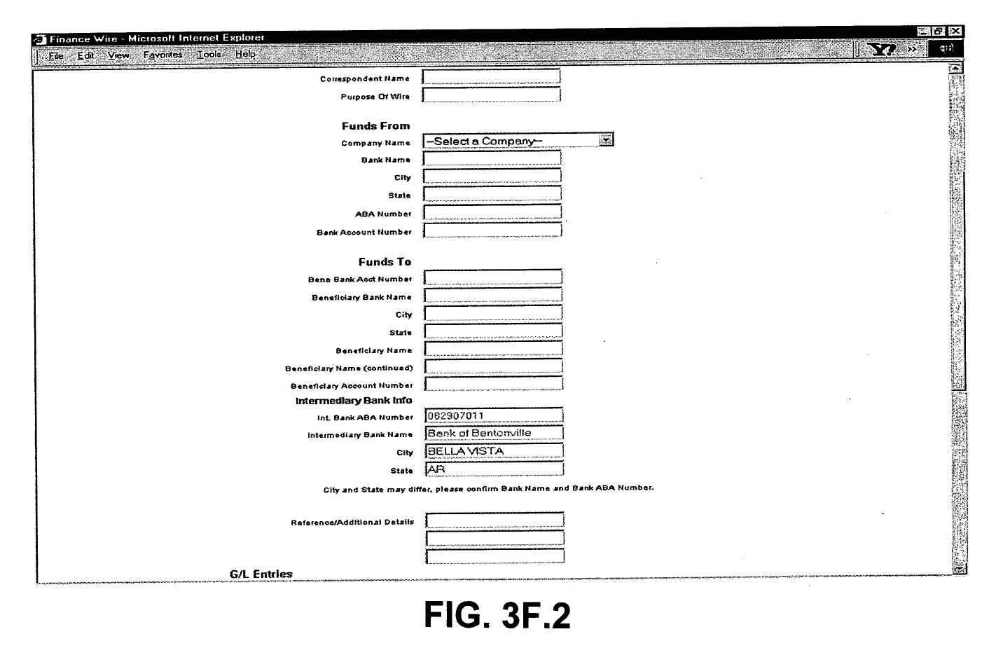

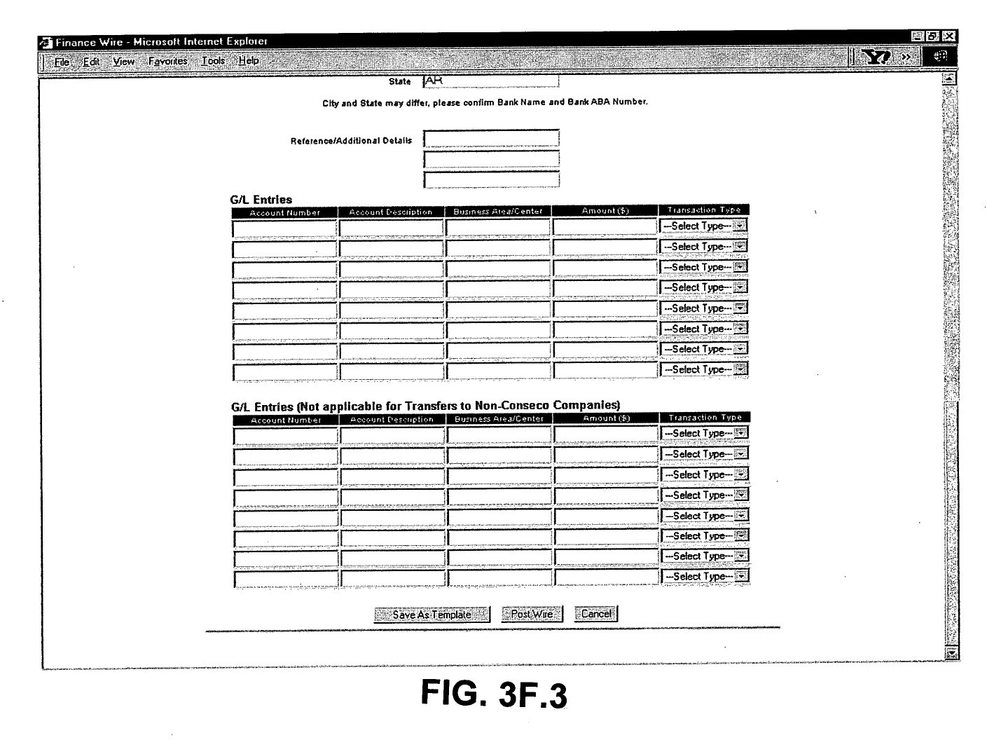

1.1 Submitter—FIG. 3 illustrates a Submitter's home page, according to a preferred embodiment. A Submitter's main function is submission of requests for wire transfers 300, but Submitters can also Change Personal Information 301, View Templates 302 in order to use a previously defined template for submission of wire transfer requests, and can perform Research 303. A Wire List 304 of the current day's wire transfer request is presented to the Submitter and any requests submitted after a predetermined Cutoff Time are noted 305. Submitters are the only users that can register without intervention by a Super Admin user.

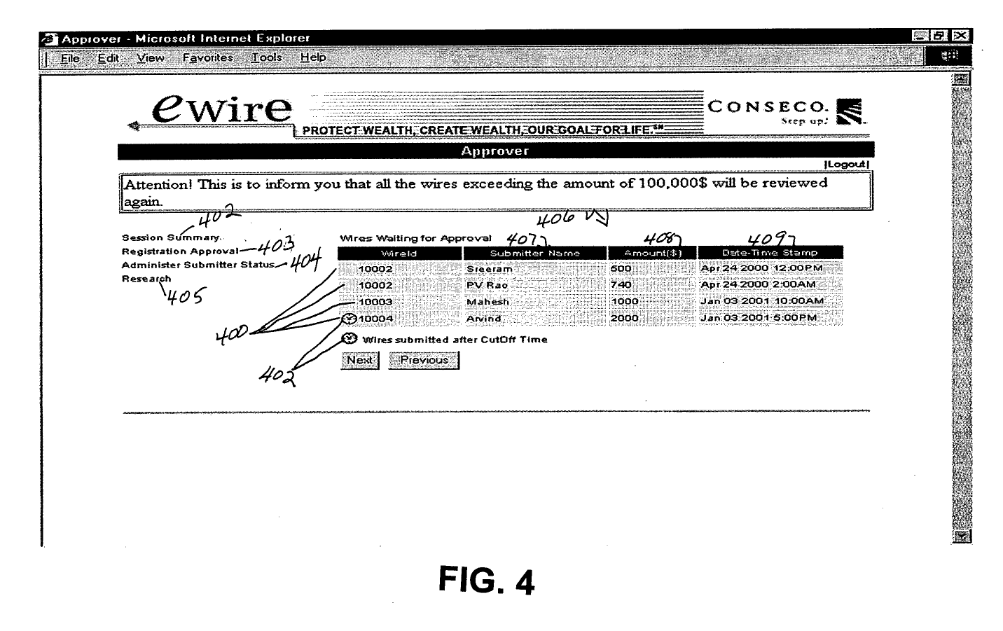

1.2 Approver—FIG. 4 illustrates an Approver's Home Page, according to a preferred embodiment. An Approver's main function is verification that a wire being submitted is valid and a list of Wire Waiting for Approval is presented to an Approver whenever the Approver accesses the Approver's Home Page. An Approver reviews the individual requests 400 and has the authority to approve or reject them. Approvers are also responsible for some levels of Submitter User Maintenance 404. Approvers authorize potential Submitters to become members of the Wire Transfer System 404. Approvers receive the Submitter registration requests and either approve or reject Submitters into the system 404. Also, they maintain a Submitter's “Active” or “Inactive” status 404 except for when the status has been set to “Inactive” by three (3) unsuccessful login attempts. Approvers are part of an Approver Group. All members of an Approver Group receive the same e-mails and notifications concerning the Submitters registered to the Approver Group. Finally, Approvers can perform research 405.

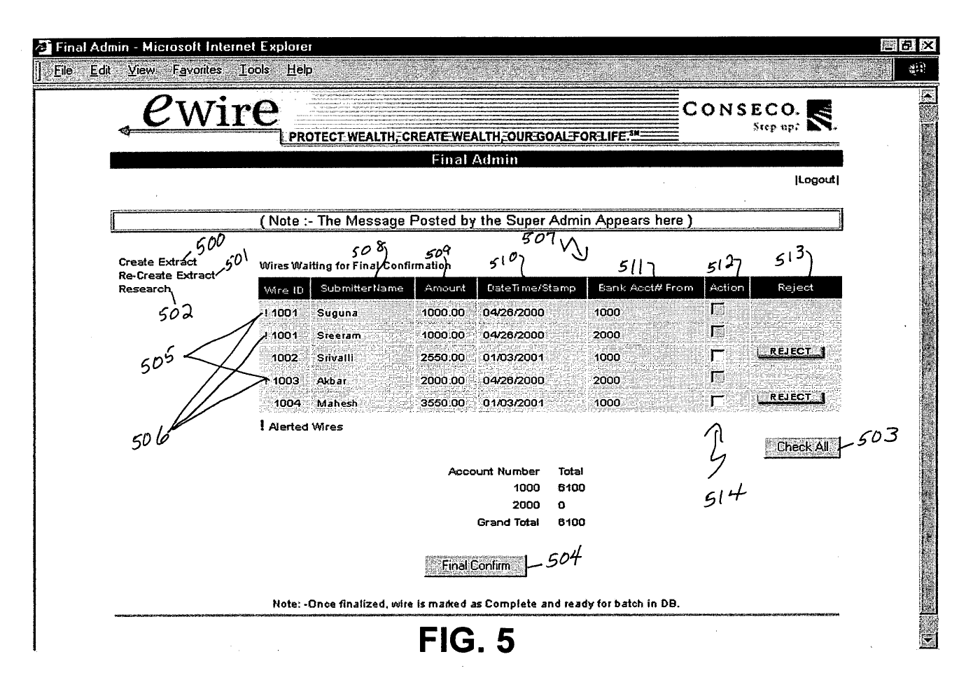

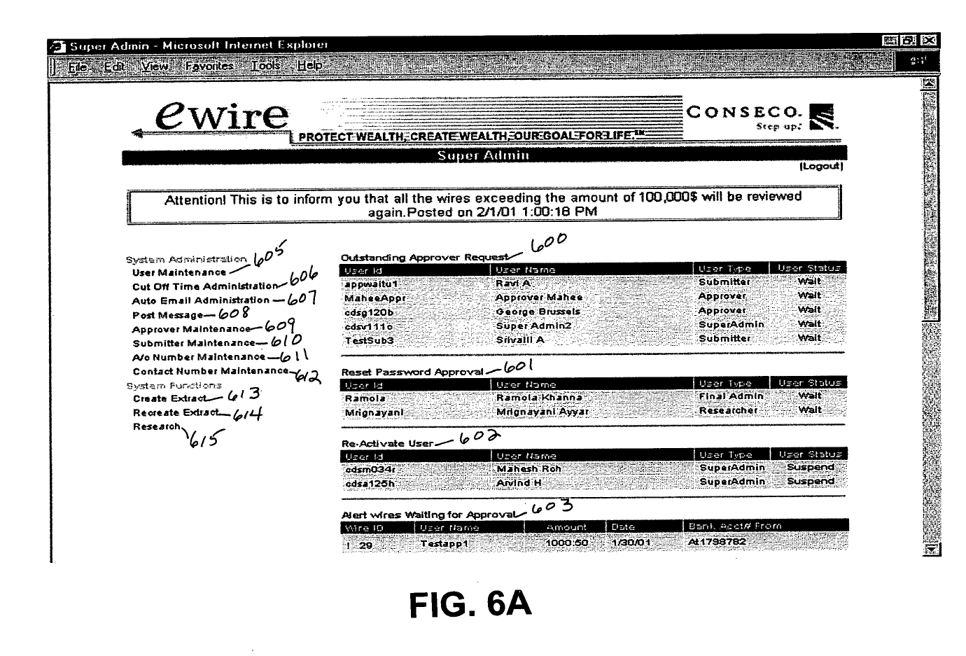

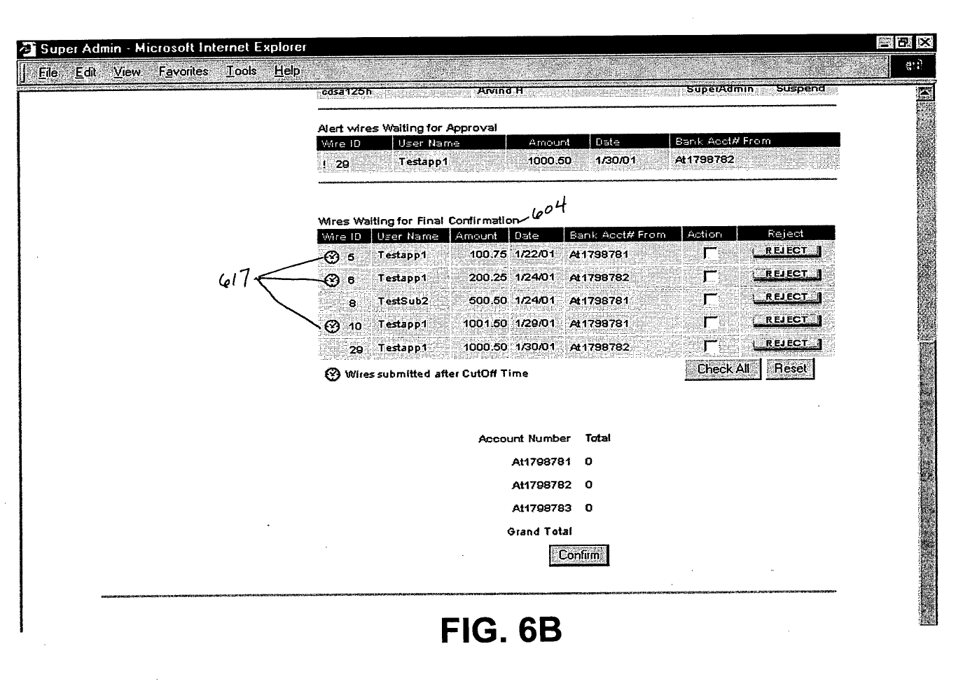

1.3 Admin—There are at least two types of Admin users in a preferred embodiment: a Final Admin and a Super Admin. FIGS. 5 and 6A-B, illustrate Home Pages for a Final Admin and a Super Admin, respectively. A Final Admin provides Final Confirmation 504 to wires that have been approved (none are shown in FIG. 5), except for wires that have been marked as “Alert Admin” 506, in which case they can see the wire in the list with a special flag, but cannot mark it as “Final Confirmation” by checking its “Action” box 507. A Final Admin creates the Batch Extract 500 of all the wires that have been given Final Confirmation. A Final Admin can also Re-Create Extract 501 for any previous Create Extract 500.

In a preferred embodiment, as illustrated in FIG. 6A, a Super Admin is responsible for all other System Administration functions and can also perform the System Functions “Create Extract”, “Recreate Extract” and perform “Research”. A Super Admin is the only user authorized with a full set of “User Maintenance” functions 605. Further, a Super Admin maintains the list of “Account From” numbers 611 that are available to Submitters when Submitters are performing a “Wire Submission Wizard”. These Super Admin functions comprise add, remove, and edit of the Account numbers that populate a dropdown list within the Wire Submission Wizard that is presented to a Submitter. Super Admin functions further comprise “Cut Off Time” administration 606. When a wire is submitted, it is automatically date/time stamped. The Super Admin can set a cut off time that causes any wire submitted after that time to be marked with a special flag, see FIG. 6B 617. This special flag 617 indicates to an Approver and Final/Super Admin that the wire was submitted after the Cut-Off time on a given day. In a preferred embodiment, no functionality is restricted on wires that are marked in this manner. These wire transfer requests can still be approved and given Final Confirmation in the same manner as any other wire, but they need to be marked as submitted after the cut-off time for Approver's and Final/Super Admin's information. The Super Admin is also responsible for creating and maintaining the content of the automatic e-mails and in a preferred embodiment can set the Subject and the Body of the e-mails that are generated for each situation that causes an auto-email (e.g., the e-mails sent to Approvers at various times throughout the day that tell them they have wires waiting for their approval). The Super Admin posts messages to a Home Page of the Application.

1.4 Researcher—A Researcher's only function is to perform and report on research regarding wire transfers. A Researcher can view data from all wires without restriction.

2. Functions

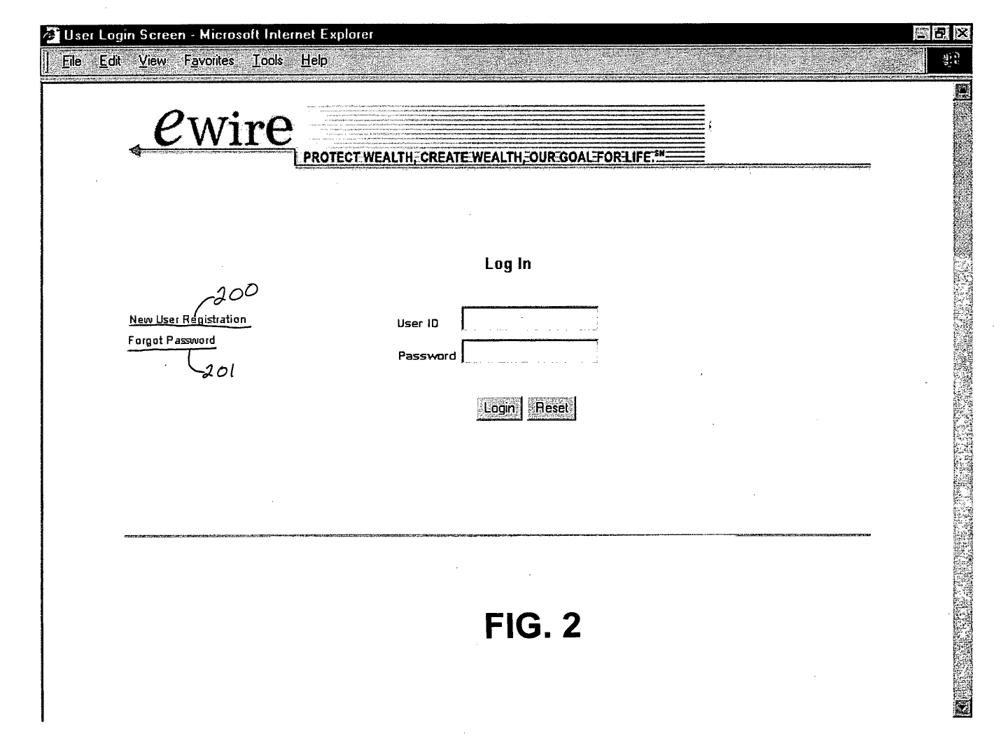

2.1 Register—In a preferred embodiment, Submitters self-register. First, the Submitter completes an on-line registration form that is displayed when the user selects the link “New User Registration” 200 in the login page illustrated in FIG. 2. The Registration Form captures various information about the Submitter (e.g., name, phone, email, etc.). The Registration Form solicits a “Password Question” that the submitter can answer in the case of a forgotten password (see Function 2.2 below: Forgot Password). Every Submitter is required to select an Approver Group from a provided and predetermined list of Approver Groups. This Approver Group comprises a number of Approvers that is to receive the e-mails that the system and method of the present invention generates concerning this Submitter's wire submissions. Each member of this Approver Group has the authority to approve or reject the Submitter's wires. Upon submission of the form, a check is performed to ensure that the username and e-mail address being submitted for registration are unique. If so, then the Submitter is presented with a display that confirms a registration request has been successfully submitted to the members of the selected Approver Group for review of the request for registration. When any one member of the Approver Group either approves or rejects the Registration, the Submitter is sent an e-mail that confirms that acceptance or informs of that rejection.

All other levels of users are to be maintained by Super Admin (see Function 2.8 below: User Maintenance).

2.2 Forgot Password 107—When a user forgets a password, the user can click on the “Forgot Password” link 201. A display is presented to the user requesting that the user to provide a username. Once the username has been entered, the user is presented with a Password Question that corresponds to the entered username. This Password Question is the same question that the user entered at the time of registration. When the answer matches the answer that corresponds to the entered username, then a confirmation page informs the user that the password has been e-mailed 113 to the email address associated with the username. If the user answers incorrectly, the user is directed to contact an Admin. In a preferred embodiment, a safeguard sets any user's account to “inactive” upon three (3) unsuccessful login attempts 102. The Password Question is available to Submitter level users only. The passwords for all other levels of users are maintained by Super Admin (see Function 7 below: User Maintenance). After the third unsuccessful login attempt in a row, the user is notified that the account corresponding to the entered username has been disabled and that a Super Admin must be contacted to have the account reactivated. Although an Approver has the ability to maintain the status of the Submitters that submit to them, this does not apply in this situation. The only user that can reactivate an account if it has been disabled by three (3) unsuccessful login attempts is a Super Admin. The disabling of the account after three (3) unsuccessful login attempts applies to every user in the system. In this situation, the only user than can switch the account back to “Active” is a Super Admin

2.3 Submit 117—In a preferred embodiment, the wire submission process is a step-by-step wizard-like process that steps the Submitter through a series of questions, with each question possibly resulting in collection of a piece of data about the wire. At the completion of the wizard, the Submitter is presented with a confirmation page that displays all of the fields and the values entered by the user into those fields. This provides the Submitter with an opportunity to review what they are about to submit, check it for accuracy, and edit the information. Several options are available at this point: Submit 125, Cancel, and Save As Template 126. Submit 125 commits the wire information to a database and adds the wire to a list 406 waiting for approval from the Submitter's Approver. Cancel discards all of the entered information and takes the Submitter back to the first step of the Wire Wizard process.

In a preferred embodiment, there is no Edit feature at the completion of the Wire Wizard process. The Submitter can either submit the entered information or must start over if there is an error that needs to be corrected. In an alternate embodiment, all or a subset of the information contained in a wire submission can be edited by the Submitter and then submitted.

Another option is to save the wire as a template 126. Submitters often request very similar wires over and over again. In order to make this process easier, in a preferred embodiment the Submitter is able to save wire templates that hold much of the repeated data. Therefore, selection of the link “Save As Template” presents a screen where an identifier can be provided by the Submitter for the saved template so that it can be retrieved and reused at a later date. After naming the template the Submitter selects a link “Save ” and selected parts of the current wire information are committed to the database as a wire template, e.g., in a preferred embodiment all data is saved except for the dollar amount and the reference/additional details fields. Then, the Submitter is redirected back to a wire confirmation page for an opportunity to Submit the original wire (non-template wire).

Once the Submitter chooses a template to reuse 121, the Submitter only needs to provide missing information, e.g., the dollar amount of the wire and any reference/additional details of the two fields that were excluded from the Save As Template process. With the missing information supplied by the Submitter, the Submitter is taken to the same confirmation page as mentioned above, and the process continues from this point in the same manner as described above.

In a preferred embodiment, the templates are local to the Submitters that create them. In other words, the wire templates that a Submitter saves are only available to that Submitter, and no other Submitters are able to access those templates. In an alternate embodiment, the templates can be shared with other users.

A template maintenance interface is also accessed from “View Templates”. The Submitter select one of the saved templates and then is shown an editable view of all of the selected template's fields and their values. After making changes the Submitter can save the revisions under either a new name, i.e., thereby creating another template, or can overwrite the existing template with the new information.

In a preferred embodiment, duplicate prevention is performed for all wire submissions. By checking selected information for duplication, e.g., for any wires with the same dollar amount, account to, and date fields from a user, inadvertent duplication of wire submissions can be prevented. If a Submitter has already submitted a wire on the same date with the same dollar amount and the same account to, the Submitter is alerted that there is already a wire submitted with the same values and the system and method of the present invention requests confirmation of submission of the duplicate. Or, the Submitter can cancel the wire submission.

In a preferred embodiment, the Submit function is available to Submitters only. In an alternative embodiment, the Submit function can be made selectively available to plurality of users or classes of users.

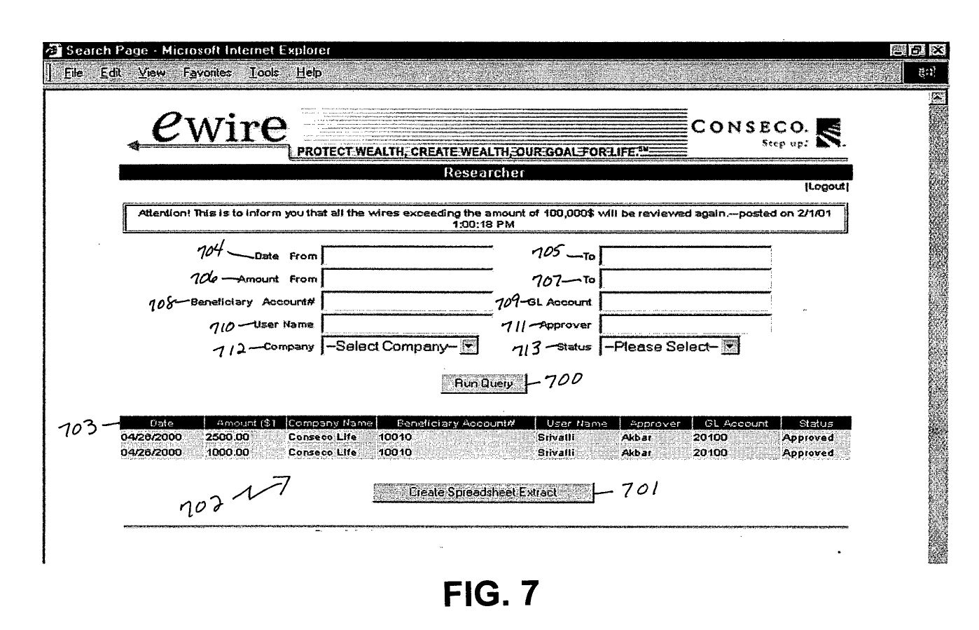

2.4 Research 119 123—The goal of the Research functionality is to provide users with a method to search 119 and retrieve 123 specific wire data or groups of wires to produce reports, e.g., spread sheet extracts 127. In a preferred embodiment, a set of predetermined fields illustrated in FIG. 7 (Date From 704 and To 705, Amount From 706 and To 707, Company To 712, Beneficiary Account 708, Submitter 710, Approver 711, General Ledger Account 709, and Status 713) are used as the search criteria to which wire submissions in the database are matched for retrieval. A user enters data in at least one of these fields to produce a set of matching wires in a results table that, in a preferred embodiment, appears on the bottom half of the search page 702. In an alternate embodiment, any field of a wire submission can be used to identify wires to be retrieved and the results are presented in any convenient manner, not necessarily on the same page in which the search criteria were entered.

Using the fields specified, a results table 702 is built by the system and method of the present invention. In a preferred embodiment, the retrieved information contained in the predetermined set of fields is presented row-by-row in a table, as well as an additional field that contains a link called “View Detail” for each row. The header row 703 of the table contains the titles for each of the predetermined fields and is clickable. Clicking on any of the titles sorts the table by that field. By clicking on the “View Detail” link for any row, the user is taken to a Detail View of all information collected about that particular wire (including all information collected when the wire was submitted, information about who approved the wire and when, and information about when it was given final confirmation and which extract it was included in). All information in the Detail View is non-editable. In an alternative embodiment, any subset of the field's of the wire submission matching the selection query can be displayed with an option to view details for any individual wire submission.

In a preferred embodiment, all users of the system and method of the present invention have the same Research functionality available to them 119, but some users have a more limited scope of wire submissions that are viewable. Specifically, a Submitter has the same Research module available but can only view wires that have been submitted by the Submitter. Approvers, can only view wires submitted by Submitters registered to them. Final and Super Admins have the same full-level access as Researchers.

The Researcher class of user can view all wires from all Submitters as can Admin and Super Admin classes of user see all wires from all Submitter users. From the Research module, all users are able to create a Spreadsheet extract on an ad-hoc basis for the wires they are permitted to view.

Alternatively, the user can selectively print the table of results, which can be first sorted as indicated above by selecting the heading of a particular column.

In an alternative embodiment, the scope of retrievals can be particularized to a user and to a class of users.

2.5 Approve 109—In a preferred embodiment, when an Approver logs in, the main page includes a table 406 of all of the wires that have been submitted and are waiting for approval by that Approver. This table shows the Submitter 407, Amount 408, and Date/Time 409 of the wires that were submitted to this Approver. As with the Research results table 702, there is also a “View Detail” button that takes the Approver to a Detail View as described above. From this Detail View, the Approver has three (3) Command Buttons available: Approve, Reject, and Alert Final Admin.

In a preferred embodiment, selection of the Approve button initiates a process 131 that causes the corresponding wire to be marked as approved in the database and then removes the approved wire the Approver's list 406 of wires waiting for approval. The wire will then be added to the list 507 that the Final Admin sees for Final Confirmation.

Selection of the Reject button initiates a process 133 that causes the corresponding wire to be marked as rejected in the database and removes the wire from the Approver's list 406. This action also causes an email to be generated and sent informing the Submitter that the wire has been rejected. The e-mail comprises elements from the database such as Wire Number, Submitter Name, Approver Name, Status (Rejected), and Status date.

Finally, selection of the “Alert Final Admin” button initiates a process 132 that removes the wire from the Approver's list 406 and enters it in the Final Admin's list 507, but the Status of the wire is set to “Alert” and it is specially denoted in the Final Admin's list as being on “Alert” status (a special flag 506 next to the wire in the list). The purpose of this functionality is to provide the Approver with an easy way to bring suspicious or suspect wire submissions to the Final Admin's attention.

In a preferred embodiment this function is available to Approver level users only. In an alternative embodiment this function is made available selectively to users.

2.6 Final Confirmation—After the Approver has marked a wire as approved, it is added to the Final Admin's list 507 of wires for review. Final Admin is able to perform all of the commands from the table itself 507.

The table the Final Admin table 507 contains the fields Submitter 508, Amount 509, Date-Time Stamp 510, and Account From 511. In addition to these fields, there are columns that contain a “View Details” link, a “Reject” button 513, and a check box 513 at the end of each row for “Final Confirmation”.

The View Details operates identically to that of the Research function. The “Reject” button operates identically to that of the Approval function with the addition of including the Approver on the distribution list for the Rejection e-mail. The check box at the end of each row that is in the Final Confirmation column is used to denote those wires that have been given final approval. The Final Admin also has a “Check All” button 503 to automatically check the boxes for all wires currently in the table 507. Then, once the Final Admin is comfortable with the wires that have been marked for Final Confirmation, pressing a “Submit Final Confirmation” button 504 marks the appropriate wires as completely authorized and ready to be included in the next extract that is created. Once the wires have received Final Confirmation and have been submitted as “Ready for Extract”, they no longer appear in the Final Admin's table 507 pf wires waiting for Final Confirmation.

In a preferred embodiment, there is at least one exception to this general procedure. If an Approver marks any wire as “Alert Final Admin” the wire has a special flag 506 next to it in the table 507. A Final Admin cannot give Final Confirmation these wires. Even if the Final Admin presses “Select All”, any wire with an “Alert” status remains unselected. The only way that an “Alert” wire can be given Final Confirmation is by approval from two (2) Super Admins. The wire has to be opened up in a Detail View by a first Super Admin user and given Final Confirmation by pressing a “Final Confirmation” by the first Super Admin. Then, a second Super Admin user has to repeat the same final confirmation process. After that happens, then the wire is included in the next Batch Extract. A message at the bottom of the Detail View of an “Alert” wire will show the status of the Super Admin confirmations. In a preferred embodiment this status message first says, “two Super Admin confirmations are required for this wire to execute”. Then, after the first Super Admin confirmation, the message says, “one Super Admin confirmation are required for this wire to execute”.

In a preferred embodiment Final Confirmation functionality is available to Admin level users only (Final Admin and Super Admin). In an alternative embodiment, Final confirmation functionality can be assigned selectively to any user.

In a preferred embodiment, “Alert” wire confirmation is available to Super Admin level users only. In an alternative embodiment, “Alert” wire confirmation functionality can be assigned selectively to any user.

2.7 Extract—In a preferred embodiment, extracts are the output files created by the system and method of the present invention and at least two different extracts that can be created, Spreadsheet and the Batch Extracts.

The Batch Extract is a file that will be imported into a Resource system for wire transaction execution. In a preferred embodiment a “Create Extract” button causes a flat file output of all of the wires that have been given Final Confirmation but have not yet been included in an extract. The database stores identifying and characteristic information about the extract at the time it is created, e.g., in a preferred embodiment, the Date/Time it was created, the identification of the user it was created by, and a broad identifier of the range of extracts that are to be included. This information needs to be stored so that it can be used in the “Recreate Extract” function in the extract. The Recreate Extract function prompts the Admin for a date or date range of the extract to be recreated. A search of the database is conducted to locate wires that fall in the range of extracts specified and the results of this search includes all extracts that were created on or within the given date range in a table that lists the Date of extract, Extract Number, a “Wires Included” link, and a “Recreate” button. The “Wires included” link takes a user to a page that lists information about the wires included in that particular extract in a format similar to the Results table 702 of the Research function.

In a preferred embodiment, whenever an extract is performed two (2) files are created. The first file created is saved using a pre-determined path and has the same name every time . . . overwriting the file that is currently there. This is the file that will be imported by the target system. At the same time, an exact duplicate of this file is created in another directory and has a name in a convention that includes the date and time of the creation, such as “MMDDYYHHMM” (for example: “1 20300-1625” would be a file created on Monday, Dec. 3, 2000 at 4:25 PM). This second extract is strictly for archival purposes.

In a preferred embodiment, a database is created and maintained by the system and method of the present invention having several pieces of information about the status of each wire and the extracts it has been included in. For example, status of each wire is maintained in the database so that all wires that have “Final Confirmation” are included in a Batch Extract. Further, in a preferred embodiment, in the database each wire has associated information stored about when and by whom it was approved, when and by whom it was given Final Confirmation, and when it was included in a Batch Extract so that all of this information can be included in any Detail View of the wire.

The second output of the system and method of the present invention is the Spreadsheet Extract. This is a CSV (Comma Separated Value) file that contains a predetermined set of information about wires. The Spreadsheet extract can be created from the Research module by any user. When a user executes a search, the matching results populate an output table. This data can be saved as a CSV file. The user selects a button “Create Spreadsheet Extract” that takes the contents of that output table, creates a CSV file, and asks the user where to save the file.

In a preferred embodiment, Create/Recreate Extract is available to Admin level users only (Final Admin and Super Admin). In an alternative embodiment, Create/Recreate Extract can be made available to selected users.

In a preferred embodiment, the Create/Recreate Spreadsheet function is available to all users and can be invoked from the Research module. In an alternative embodiment, other means such as a menu selection is available to gain access to the Create/Recreate Spreadsheet function.

2.8 User Maintenance—In a preferred embodiment, the Super Admin is the only user with the ability to add, remove, or modify ALL users within the present invention (including other Super Admins). The Approvers are able to maintain only “Active” or “Inactive” status of the Submitters directly registered to them. Therefore, Super Admin and Approver users are the only ones with a link to the User Maintenance area. In an alternative embodiment, selected user can add, remove, and modify all users with the system and method of the present invention.

In a preferred embodiment, for Super Admins, the main User Maintenance page comprises a text box to use to search on the Last Name field of all user records in the database. The results of this search are displayed on the same page, just below the search section. The results table comprises the matching users' First Name, Last Name, e-mail Address and Status fields, along with a “View Detail” link in the last column. By clicking on the “View Detail” link, the user is taken to a screen that displays all of the selected user's information. From this screen, the Admin can update, change, or add any piece of data. Status changes also take place using this screen, with the available choices being Active, Suspended, and Deleted. Pressing a “Submit” button on this page commits the changes, while pressing a “Cancel” button takes the user back to the main User Maintenance page without updating the user record. Whenever a user is marked as “Deleted”, the user's information is not removed from the database but rather their status and access rights are updated to reflect this status.

In a preferred embodiment, another option available to a Super Admin in the main User Maintenance page is the “Add New User” option. The Super Admin has the ability to add any type of user. A new user is added to a list that only Super Admins can see. This list contains all functions that require two (2) Super Admin approvals to execute. Adding a new user is one of these functions that requires two (2) Super Admin approvals, so it is added to the list and only executes after another Super Admin logs in, checks this list, and approves the new user. In a preferred embodiment, an Edit page is used to maintain the association between Submitters and Approver Groups. In order to select an Approver Group, a new Submitter user employs a dropdown list that is populated with all of the current Approver Groups. For maintaining the list of Submitters that an Approver Group is responsible for, another dropdown list contains all of the names of the Submitters that an Approver Group is responsible for in alphabetical order by last name (in the Submitter's user record, Approver Group=the Approver Group being edited).

In a preferred embodiment, an interface is provided to build and maintain the Approver Groups. Approver Groups are sets of multiple Approvers given a common name. When a Submitter Self-Registers, the registrant picks an Approver Group. All members of the Approver Group receive the same e-mail and notification about the Submitters registered to them and the wires that are submitted and waiting for approval. The Super Admin creates, edits, and delete groups of Approvers and give each group a unique name. In an alternative embodiment, any user can be selectively assigned this function with respect to groups of Approvers. In a preferred embodiment, an Approver Group can only be deleted if all of the Submitters under that Approver Group have been removed from that Approver Group.

In a preferred embodiment, Approvers are responsible for a certain portion of User Maintenance, i.e., Approve/Reject Registrations 143 and Activate/Inactivate Users 140. When a potential Submitter requests to be added to the application, these requests are directed to the Approvers at New Registrations 142.

In a preferred embodiment, the Approvers are able to see a list of all of the Submitters that are registered to them. Each Approver has the ability to switch a Submitter's status from “Active” to “Inactive” (or from “Inactive” back to “Active”) 140. The only time that an Approver does not have this ability is when a Submitter's status is switched to “Inactive” because of three (3) failed login attempts in a row. In this situation, only the Super Admin can change the Submitter's status back to “Active”.

In a preferred embodiment full User Maintenance functions are available to Super Admin level users only. In an alternative embodiment, these functions can be selectively assigned to users.

In a preferred embodiment Approve/Reject requests for Registration and Administration of Submitter Status functionality is available to Approver level users only. In an alternative embodiment, these functions can be selectively assigned to users.

It will be apparent to those of skill in the appertaining arts that various modifications can be made within the scope of the above invention. Accordingly, this invention is not to be considered limited to the specific examples, e.g., page formats, chosen for purposes of disclosure, but rather to cover all changes and modifications which do not constitute departures from the permissible scope of the present invention as defined by the appended claims.

What is claimed is:

1. A wire transfer request preparation system with administration, said system comprising:
a plurality of rules to control preparation and administration of a wire transfer request;
a plurality of roles to accomplish preparation and administration of a wire transfer;
means for preparation and administration of a wire transfer request for approval by said roles according to said rules; and
a database for storing rules, roles, and a wire transfer request prepared and administered by said roles according to said rules.

2. A wire transfer request preparation system with administration according to claim 1, wherein said database is networked.

3. A wire transfer request preparation system with administration according to claim 1, wherein:
said database is accessible over the Internet, and
and said preparation means comprises a Web browser.

4. A wire transfer request preparation system with administration according to claim 1, wherein said means for preparation and administration of a wire transfer request comprises:
at least one wire transfer request template for preparing an instance of a wire transfer request, said instance having a status for indicating its stage of administration, said template defining a plurality of entries for each wire transfer request.

5. A wire transfer request preparation system with administration according to claim 4, wherein:
each of said plurality of entries defined by said at least one template is associated with and controlled by at least one of said plurality of rules; and
said database stores said at least one template.

6. A wire transfer request preparation system with administration according to claim 5, wherein said plurality of rules comprises at least one rule for determining a cut off time for submission of a wire transfer request.

7. A wire transfer request preparation system with administration according to claim 5, wherein:
at least one of said plurality of roles is associated with each template and with each instance of a template, i.e., wire transfer request; and
said database stores said plurality of roles and the association of each said role with each said template and each said instance of each said template.

8. A wire transfer request preparation system with administration according to claim 7, wherein each of said plurality of roles performs at least one of:
creating, editing, reporting, and database storing of said at least one template and said associated rules; and
creating, editing, setting said status, reporting, and database storing of a template instance of a wire transfer request, of said at least one template according to said associated rules.

9. A wire transfer request preparation system with administration according to claim 8, wherein said means for preparation and administration of a wire transfer request further comprises:
a database accessing device to allow at least one of said plurality of roles to access at least one of said templates stored in said database in order to perform at least one of creating, editing, and reporting an instance of a wire transfer request, and setting said status of an instance according to said associated rules;
a database storing device to allow at least one of said plurality of roles to store in said database said wire transfer request having said set status.

10. A wire transfer request preparation system with administration according to claim 4, wherein each of said plurality of entries is selected from the group consisting of wire transfer identifier, wire amount, account number wire to bank information, wire to bank account information, wire from bank information, wire from bank account information, GL (General Ledger) entries balancing information, purpose of the wire and reference information.

11. A method for wire transfer request preparation with administration, comprising the steps of:
a. specifying rules to control preparation and administration of wire transfer requests;
b. specifying roles to accomplish preparation and administration of wire transfer requests;
c. preparing and administering wire transfer requests by said specified roles according to said specified rules;
d. storing said specified rules and roles in a database; and
e. storing said prepared wire transfer requests in a database.

13. The method for wire transfer request preparation with administration according to claim 12, wherein step (c) further comprises the steps of:
c.1 providing at least one template for preparation of an instance of a wire transfer request;
c.2 defining in said at least one template a plurality of entries for each said instance of a wire transfer request, said plurality of entries comprising a status for indicating the stage of preparation and administration of the instance; and
c.3 storing said at least one template in a database.

14. The method for wire transfer request preparation with administration according to claim 13, wherein step (a) further comprises the steps of:
a.1 providing a plurality of rules to govern preparation and administration of wire transfer requests;
a.2 associating each of said plurality of entries with at least one of said provided plurality of rules;
a.3 storing in a database said each of said plurality of rules and said association with said entries.

15. The method for wire transfer request preparation with administration according to claim 13, wherein step (d) further comprises the steps of:
d.1 providing a plurality of roles for preparation and administration of wire transfer requests;
d.2 associating at least one of said plurality of roles with each said template; and
d.3 storing in a database said plurality of roles and said association of at least one of said plurality of roles with said template.

16. The method for wire transfer request preparation with administration according to claim 15, wherein step (d) further comprises the steps of:
d.4 creating, editing, reporting, and storing in a database by said associated at least one of said plurality of roles of said at least one template and said associated rules;
d.5 creating, editing, setting said status, reporting, and storing in a database by said associated at least one of said plurality of roles said template instances of data transfer requests of said at least one template in accordance with said associated rules;
d.6 retrieving from said database and editing, setting said status, reporting of said stored instances of data transfer requests in accordance with said associated business rules by said associated at least one of said plurality of roles; and
d.7 restoring in said database of said retrieved instances that have been edited and that have had their status set.

17. A wire transfer request preparation system with administration according to claim 1, said system further comprising:
a host system;
data storage means within said host system for maintaining said database containing a plurality of data records of differing types comprising: templates, instances of wire transfer requests; rules, and roles;
a plurality of remote communications facilities;
communication network means for exchanging data between said host computer system and each of said plurality of remote communication facilities;
computer processing means associated with said host enabling said host to accept and store and retrieve and transmit database records from and to respectively, one of said remote communications facilities according to criteria provided by said one of said plurality of remote communications facilities; and
computer input means at each remote communications facility permitting from said remote communications facilities:
a. specification of the inputs to define roles and rules,
b. implementation of said roles, and
c preparation and administration of wire transfer requests.

18. A wire transfer request preparation system with administration according to claim 17, wherein the communications network means is the Internet and said computer input means employs a Web browser.
